(19) United States
(12) Patent Application Publication
(10) Pub. No.: US 2008/0276299 A1
(43) Pub. Date: Nov. 6, 2008

(54) WIRELESS TERMINAL APPARATUS AND METHOD OF PROTECTING SYSTEM RESOURCES

(75) Inventors: Sung-Min LEE, Suwon-si (KR); Sang-Dok MO, Suwon-si (KR); Bok-Deuk JEONG, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/034,923

(22) Filed: Feb. 21, 2008

Related U.S. Application Data
(60) Provisional application No. 60/907,419, filed on Apr. 2, 2007.

(30) Foreign Application Priority Data
Oct. 24, 2007 (KR) 10-2007-0107421

(51) Int. Cl. G06F 21/00; H04M 1/00

(52) U.S. Cl. 726/2; 455/574; 713/189

(57) ABSTRACT

A wireless terminal apparatus is provided, which includes a domain unit having a first domain which drives a first application and a second domain, separated from the first domain, which drives a second application; a system resource unit composed of hardware of the wireless terminal apparatus; and a control unit which controls an operation of the domain unit that accesses the system resource unit.

### CROSS-REFERENCE TO RELATED APPLICATION

This application claims priority from U.S. Provisional Application No. 60/907,419 filed on Apr. 2, 2007 in the United States Patent and Trademark Office, and Korean Patent Application No. 10-2007-0107421 filed on Oct. 24, 2007 in the Korean Intellectual Property Office, the disclosures of which are incorporated herein in their entirety by reference.

### BACKGROUND OF THE INVENTION

1. Field of the Invention

The present invention relates to a wireless terminal apparatus such as a mobile phone, and more particularly to a wireless terminal apparatus and a method of protecting system resources of the wireless terminal apparatus from malicious software (“malware”) attack to guarantee safe security services in a wireless environment.

2. Description of the Related Art

Generally, a wireless terminal apparatus, such as a mobile phone, provides diverse information services in a wireless environment.

FIG. 1 is a block diagram illustrating the construction of a related art wireless terminal apparatus.

As illustrated in FIG. 1, the related art terminal apparatus includes a domain unit 10 provided with one operating system (OS) 11 and applications 12, and a system resource unit 20 provided with a ROM, a central processing unit (CPU), a memory, a battery, an input/output (I/O) device, and so forth. In the related art terminal apparatus, applications 12 including voice call, banking, trading, digital rights management (DRM), and so forth, are driven by one operating system 11.

According to the related art wireless terminal apparatus as described above, however, all applications 12 are operated by one operating system 11 irrespective of the degree of security, and thus, if malicious software is installed in the wireless terminal apparatus without the user's knowledge in a wireless environment, wireless data information and system resources of the wireless terminal apparatus cannot be protected from malware attack, and safe security services cannot be guaranteed.

More specifically, the malware consumes battery power of the wireless terminal apparatus to make important services unusable. Also, when a received message, such as a Short Message Service (SMS)/Multimedia Messaging Service (MMS) message that includes malware, is executed, the whole system is damaged, hindering the availability of the wireless terminal apparatus.

In addition, when operation such as encryption or decryption is performed in a memory of the wireless terminal apparatus, the malware can monitor the contents of the memory before the performance of the encryption or decryption, and thus the user's secret data may flow out.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provides a wireless terminal apparatus, which includes a domain unit having a first domain driving a first application that is very safe and a second domain separated from the first domain and driving a second application that is weak in safety; a system resource unit composed of hardware of the wireless terminal apparatus; and a control unit controlling an operation of the domain unit that accesses the system resource unit.

Another aspect of the present invention provides a method of protecting system resources for a wireless terminal apparatus, which includes (a) calculating a current amount of battery power used for a second domain, which is separated from a first domain driving an application that requires safety and drives a general application that is weak in safety, and a current remaining amount of battery power of the wireless terminal apparatus; (b) interrupting the driving of the second domain if the current remaining amount of battery power of the wireless terminal apparatus calculated at the step (a) is below a minimum reference value for stably driving an important service; and (c) gradually reducing an amount of CPU usage of the second domain if the current remaining amount of battery power of the wireless terminal apparatus is above the minimum reference value and the current amount of battery power used for the second domain is above a maximum reference value.

### BRIEF DESCRIPTION OF THE DRAWINGS

The above and other features of the present invention will be more apparent from the following detailed description taken in conjunction with the accompanying drawings, in which:

FIG. 1 is a block diagram illustrating the construction of a related art wireless terminal apparatus;

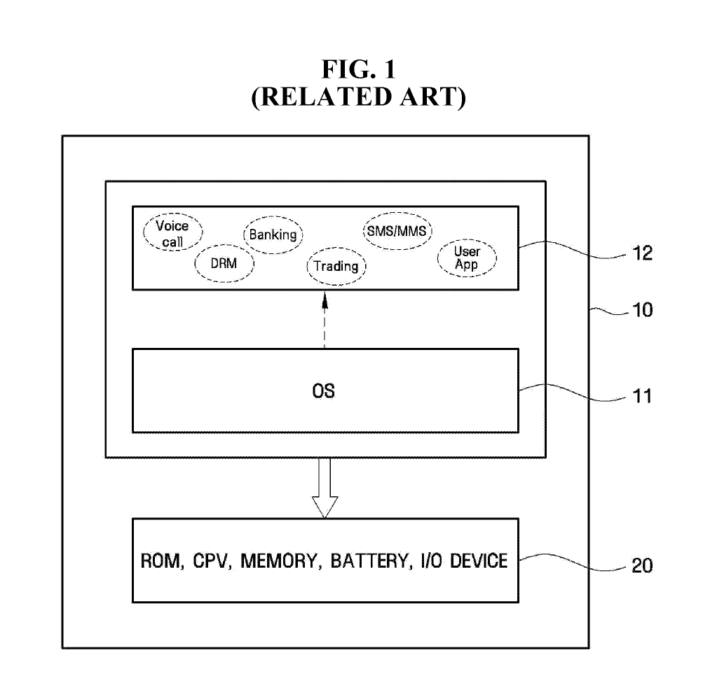

FIG. 2 is a block diagram illustrating the construction of a wireless terminal apparatus according to an exemplary embodiment of the present invention;

FIG. 3 is a flowchart explaining a method of processing malware attack against a battery in a wireless terminal apparatus according to an exemplary embodiment of the present invention;

FIG. 4 is a flowchart explaining a method of performing at least one of encryption and decryption in a wireless terminal apparatus according to an exemplary embodiment of the present invention; and

FIG. 5 is a flowchart explaining a method of performing SMS/MMS data backup in a wireless terminal apparatus according to an exemplary embodiment of the present invention.

### DETAILED DESCRIPTION OF THE EXEMPLARY EMBODIMENTS

Exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

Hereinafter, a wireless terminal apparatus and a method of protecting system resources according to exemplary embodiments of the present invention will be described in detail with reference to the accompanying drawings. In the following description of the present invention, a detailed description of known functions and configurations incorporated herein will be omitted when it may obscure the subject matter of the present invention.

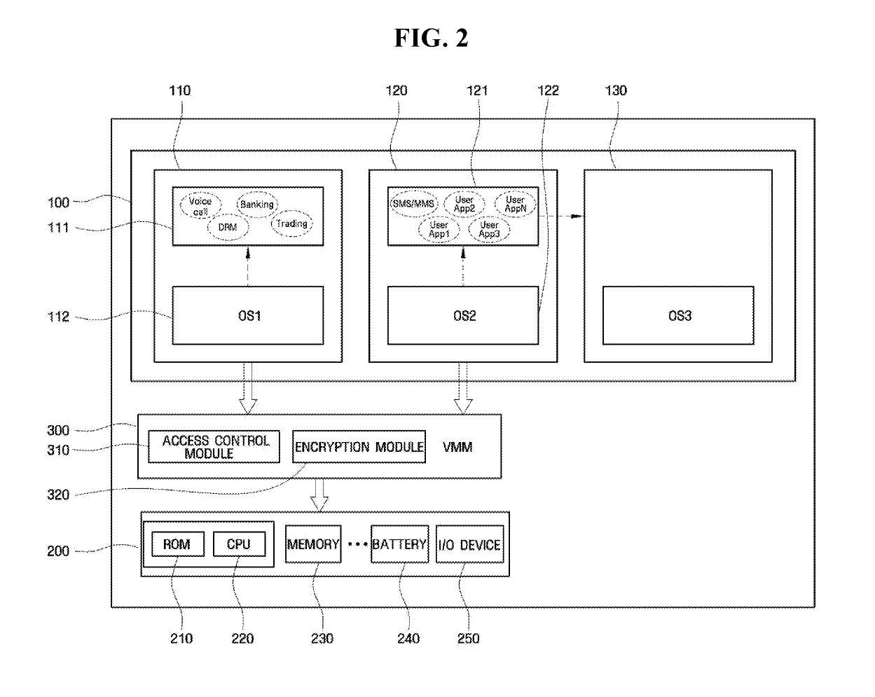

FIG. 2 is a block diagram illustrating the construction of a wireless terminal apparatus according to an exemplary embodiment of the present invention.

As illustrated in FIG. 2, the wireless terminal apparatus according to an exemplary embodiment of the present invention includes a domain unit 100, a system resource unit 200, a control unit 300, and so forth.

The domain unit 100 is an environment in which applications are operated by corresponding operating systems (OS). The domain unit 100 includes first, second, and third domains 110, 120, and 130.

The first domain 110 downloads a first application 111 that requires safety from an authenticated wireless internet server, and installs the downloaded first application 111. The first operating system (OS1) 112 executes the first application 111. The first application 111 includes applications for providing services such as voice call, banking, trading, digital rights management (DRM), and so forth.

The second domain 120 is separated from the first domain 110, and downloads a second application 121, which is somewhat weak in safety and may be attacked by malware, from a general wireless internet server to install the downloaded second application 121. The second operating system (OS2) 122 executes the second application 121. The second application 121 includes applications for providing services such as SMS/MMS, user APP, and so forth.

The third domain 130 is separated from the first and second domains 110 and 120, and makes a backup of important data information of the second domain 120 in order to prevent the important data information from being deleted or changed due to the execution of malware included in the second application 121. In order to minimize the damage to the system when the SMS/MMS including the malware is executed, the third domain 130 only performs the data backup without executing the backup data information.

The system resource unit 200 is composed of hardware of the wireless terminal apparatus. The system resource unit 200 includes a ROM 210, a CPU 220, a memory 230, a battery 240, an input/output (I/O) device 250, and so forth. Here, the ROM 210 is a storage region that cannot be illegally changed by a user or system. The memory 230 is a storage device in which wireless data information is stored, and includes a nonvolatile memory, for example, a flash memory. The memory has a plurality of storage regions in which diverse kinds of wireless data information are dividedly stored according to their kinds and security. Important data information may be encrypted and the encrypted information may be stored in a specified storage region among the storage regions.

The control unit 300 controls the operation of the domain unit 100 using a virtual machine monitor (VMM) so that the domain unit 100 can access the system resource unit 200. In order to protect the system resource unit 200, the control unit 300 is provided with an access control module 310 and an encryption module 320.

The access control module 310 controls the operation of the second domain 120 that accesses the system resource unit 200 in order to react to the malware attack against the system resource unit 200. For example, in the event that the malware included in the second application 121 of the second domain 120 attacks the battery 240 in the system resource unit 200, the access control module 310 interrupts the driving of the second domain 120 if the current remaining amount of battery power of the wireless terminal apparatus is below a minimum reference value for stably driving an important service. On the other hand, the access control module 310 gradually reduces the amount of CPU usage of the second domain 120 if the current remaining amount of battery power of the wireless terminal apparatus is above the minimum reference value and the current amount of battery power used for the second domain 120 is above a maximum reference value. Here, the minimum reference value and the maximum reference value are reference values predefined during the setting of the wireless terminal apparatus.

The encryption module 320 performs encryption and decryption of the important data information being input from the first and second domains 110 and 120 to the system resource unit 200. For example, the encryption module 320 performs encryption, decryption, and electronic signature of the important data information using VMM in the case where the wireless terminal apparatus does not support a hardwired encryption function.

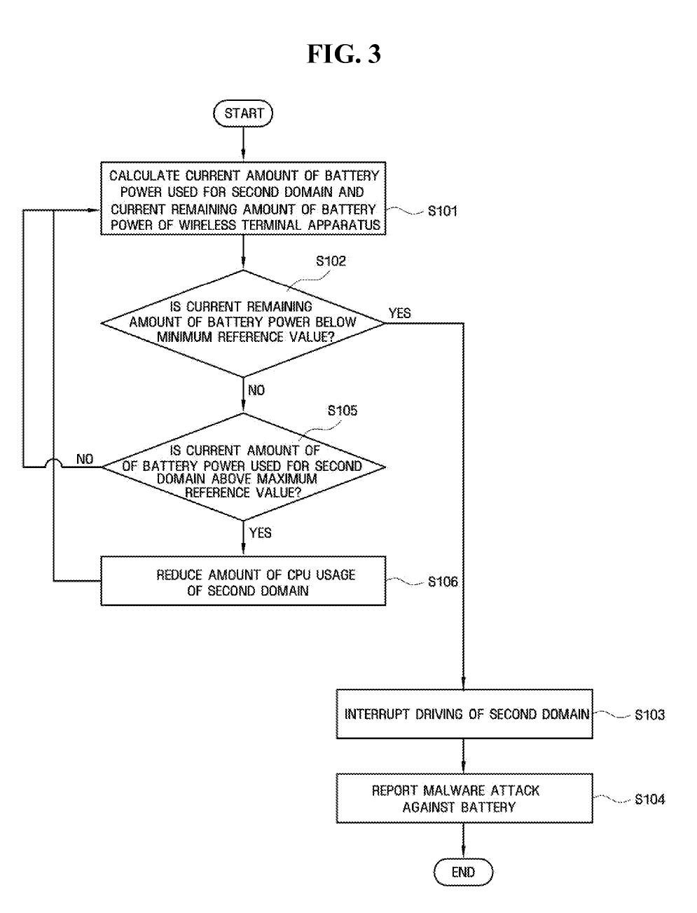

Hereinafter, with reference to FIGS. 3 to 5, the method of protecting the system resources for a wireless terminal apparatus according to an exemplary embodiment of the present invention will be described in detail.

FIG. 3 is a flowchart explaining a method of processing malware attack against a battery in a wireless terminal apparatus according to an exemplary embodiment of the present invention.

As illustrated in FIG. 3, in the case where the battery 240 of the wireless terminal apparatus is attacked by malware, the wireless terminal apparatus according to the present invention guarantees the availability of the battery 240 by managing the corresponding domain.

More specifically, when the malware included in the second application 121 of the second domain 120 attacks the battery 240 of the system resource unit 200, the current amount of battery power used for the second domain 12 and the current remaining amount of battery power of the wireless terminal apparatus are calculated S101. Then, if the current remaining amount of battery power of the wireless terminal apparatus is below the minimum reference value for stably driving the important service S102, the driving of the second domain 120 is interrupted S103, and the malware attack against the battery 240 is reported to the user S104. Then, if the current remaining amount of battery power of the wireless terminal apparatus is above the minimum reference value and the current amount of battery power used for the second domain 120 is above the maximum reference value S105, the amount of CPU usage of the second domain 120 is kept within the maximum reference value S106 by gradually reducing the amount of CPU usage of the second domain 120. Here, the battery consumption is in close relation to the amount of CPU usage.

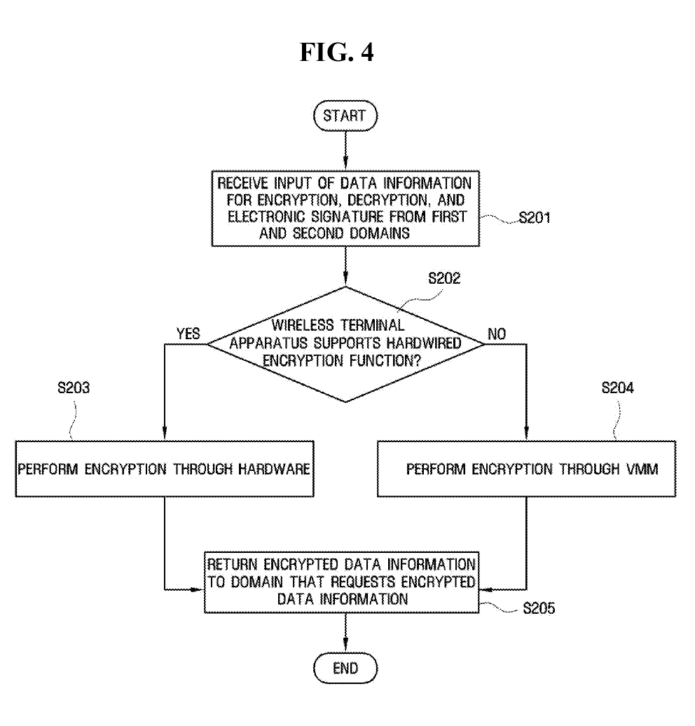

FIG. 4 is a flowchart explaining a method of performing at least one of encryption and decryption in a wireless terminal apparatus according to an exemplary embodiment of the present invention.

As illustrated in FIG. 4, according to the encryption/decryption method for the wireless terminal apparatus according to the present invention, encryption/decryption of the important data information, which is input from the first and second domains 110 and 120 to the system resource unit 200 that is composed of hardware of the wireless terminal apparatus, is performed, and thus, security is improved.

More specifically, data information for encryption, decryption, and electronic signature is input from the first and second domains 110 and 120 S201. Then, it is confirmed whether the wireless terminal apparatus supports hardwired encryption operation of the input data information S202. If the wireless terminal apparatus supports the hardwired encryption operation, the encryption operation is performed through high-speed hardware S203, while if not, a software encryption operation is performed through the control unit 300 using VMM S204. Then, the encrypted data information is returned to the respective domains 110 and 120 requesting the encrypted data information S205.

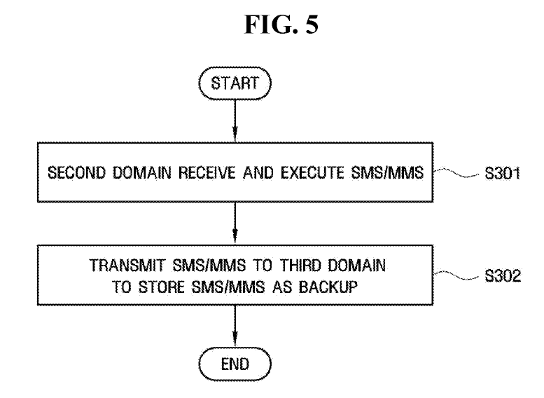

FIG. 5 is a flowchart explaining a method of performing SMS/MMS data backup in a wireless terminal apparatus according to an exemplary embodiment of the present invention.

As illustrated in FIG. 5, according to the exemplary embodiment of the present invention, the SMS/MMS message is stored as a backup in the third domain 130 that is separated from the first and second domains 110 and 120 in order to prevent the SMS/MMS message from being deleted or changed due to the execution of the malware included in the SMS/MMS message.

More specifically, the second domain 120 receives and executes the SMS/MMS message S301, and then transmits the received SMS/MMS message to the third domain 130, so that the third domain 130 stores the transmitted SMS/MMS message S302. In this case, in order to minimize the damage of the system when the SMS/MMS including the malware is executed and to perform data restoration, the third domain 130 only stores the backup data information without executing the backup data information.

As described above, the wireless terminal apparatus and the method of protecting system resources according to the exemplary embodiments of the present invention have one or more effects as follows.

First, by separating the operating system, in which an application that requires safety and should be protected from malware attack is executed, from general applications that are weak in safety, the security of the wireless terminal apparatus may be improved.

Second, by protecting the system resources of the wireless terminal apparatus from malware attack, for example, by preventing the battery consumption due to the malware attack, the availability of the wireless terminal apparatus may be increased.

Third, by performing encryption/decryption of important data information of the wireless terminal apparatus, security for the important data information may be improved.

Fourth, by performing a backup of the important data information of the operating system in which general applications are executed, the important data information is prevented from being deleted or changed due to the execution of malware included in the general applications.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A wireless terminal apparatus comprising:
a domain unit having a first domain which drives a first application, and a second domain, separated from the first domain, which drives a second application;
a system resource unit; and
a control unit which controls an access operation of the domain unit that accesses the system resource unit.

2. The wireless terminal apparatus of claim 1, wherein the first application comprises an application which provides at least one of voice call, banking, trading, and digital rights management (DRM) services.

3. The wireless terminal apparatus of claim 1, wherein the second application comprises an application which provides a Short Message Service (SMS)/Multimedia Messaging Service (MMS) service.

4. The wireless terminal apparatus of claim 1, wherein the system resource unit comprises at least one of a memory, a battery, and a central processing unit (CPU).

5. The wireless terminal apparatus of claim 1, wherein the control unit controls the access operation of the domain unit using a virtual machine monitor (VMM).

6. The wireless terminal apparatus of claim 1, wherein the control unit comprises an access control module which controls an operation of the second domain that accesses the system resource unit to react to a malware attack against the system resource unit.

7. The wireless terminal apparatus of claim 6, wherein the access control module interrupts the driving of the second domain if a current remaining amount of battery power of the wireless terminal apparatus is below a minimum reference value for stably driving a service.

8. The wireless terminal apparatus of claim 7, wherein the access control module gradually reduces an amount of central processing unit (CPU) usage of the second domain if the current remaining amount of battery power of the wireless terminal apparatus is above the minimum reference value and a current amount of battery power used for the second domain is above a maximum reference value.

9. The wireless terminal apparatus of claim 1, wherein the control unit comprises an encryption module which performs at least one of encryption and decryption of data information input to the system resource unit.

10. The wireless terminal apparatus of claim 9, wherein the encryption module performs encryption, decryption, and electronic signature of the data information using a virtual machine monitor (VMM) if the wireless terminal apparatus does not support a hardwired encryption function.

11. The wireless terminal apparatus of claim 1 further comprising a third domain which performs a backup of data information of the second domain to prevent the data information from being deleted or changed due to an execution of malware included in the second application.

12. The wireless terminal apparatus of claim 11, wherein the third domain only stores the backup data information without executing the backup data information.

13. A method of protecting system resources for a wireless terminal apparatus, the method comprising:
(a) calculating a current amount of battery power used for a second domain, which is separated from a first domain driving a first application, and drives a second application, and a current remaining amount of battery power of the wireless terminal apparatus;
(b) interrupting the driving of the second domain if the current remaining amount of battery power of the wireless terminal apparatus calculated at operation (a) is below a minimum reference value for stably driving a service; and
(c) gradually reducing an amount of central processing unit (CPU) usage of the second domain if the current remaining amount of battery power of the wireless terminal apparatus is above the minimum reference value and the current amount of battery power used for the second domain is above a maximum reference value.

14. The method of claim 13 further comprising (d) performing at least one of encryption decryption of the data information which is input from the first and second domains to a system resource unit of the wireless terminal apparatus.

15. The method of claim 14, wherein operation (d) comprises:
(d1) receiving an input of data information for encryption, decryption, and electronic signature from the first and second domains;
(d2) performing an encryption operation of the data information input at operation (d1) if the wireless terminal apparatus supports a hardwired encryption function, while the control unit uses a virtual machine monitor (VMM) performing a software encryption operation if the wireless terminal apparatus does not support the hardwired encryption function; and
(d3) returning the data information encrypted at operation (d2) to the domain requesting the encrypted data information.

16. The method of claim 14 further comprising (e) the second domain storing as a backup a Short Message Service (SMS)/Multimedia Messaging Service (MMS) message in a third domain that is separated from the first and second domains to prevent the SMS/MMS message from being deleted or changed due to an execution of malware included in the SMS/MMS message.

17. The method of claim 16, wherein operation (e) comprises:
(e1) the second domain receiving and executing the SMS/MMS message; and
(e2) transmitting the SMS/MMS message to the third domain to store the SMS/MMS message in the third domain.
